(19) United States
(12) Patent Application Publication
(10) Pub. No.: US 2004/0016069 A1
(43) Pub. Date: Jan. 29, 2004

(54) Electric toothbrush

(75) Inventor: Ka Fai Lee, Hong Kong (HK)

Correspondence Address: ROBERT R. PRIDDY, HALL, PRIDDY, MYERS & VANDE SANDE, SUITE 200, 10220 RIVER ROAD, POTOMAC, MD, 20854, US

(73) Assignee: SUN LUEN ELECTRICAL MFG. CO. LTD., Hong Kong (HK)

(21) Appl. No.: 10/202,678

(22) Filed: Jul. 25, 2002

(51) Int. Cl. A61C 17/34

(52) U.S. Cl. 15/28

(57) ABSTRACT

An electric toothbrush (10) is disclosed as including an electric motor (22), a shaft (56) engaged with a brush head (18), and a coupling mechanism operatively associated with the motor (22) and the shaft (56) for transmitting the motional output of the motor (22) to drive the shaft (56) to swivel about its longitudinal axis, the coupling mechanism including a reciprocating block (34) reciprocable along a straight line perpendicular to the longitudinal axis of the shaft (56).

This invention relates to an electric toothbrush, and in particular, such a toothbrush with a shaft adapted to be engaged with a brush head, and to swivel about its longitudinal axis.

### BACKGROUND OF THE INVENTION

There are many different constructions of electric toothbrushes. In such existing electric toothbrushes, a coupling mechanism is arranged between an electric motor and a shaft to which a brush head is attached, so that the output of an output spindle of the motor is transmitted to cause the shaft, and thus the brush head, to perform a brushing movement. Conventional coupling mechanisms are usually rather complicated and, given the relatively small size of an electric toothbrush, costly to produce.

It is thus an object of the present invention to provide a new electric toothbrush with a coupling mechanism of a relatively simple construction, and is thus less costly to manufacture, or at least to provide a useful alternative to the public.

### SUMMARY OF THE INVENTION

According to the present invention, there is provided an electric toothbrush including an electric motor, a shaft member adapted to be engaged with a brush member, and a coupling mechanism operatively associated with said motor and said shaft member for transmitting the motional output of said motor to drive said shaft member to swivel substantially about its longitudinal axis, wherein said coupling mechanism includes a movable member adapted to reciprocate along a substantially straight line which is substantially perpendicular to said longitudinal axis of said shaft member.

### BRIEF DESCRIPTION OF THE DRAWINGS

A preferred embodiment of an electric toothbrush according to the present invention will now be described, by way of example only, and by reference to the accompanying drawings, in which:

FIG. 1 is a front perspective view of an electric toothbrush according to the present invention;

FIG. 2A is an enlarged exploded view of the coupling mechanism in the electric toothbrush shown in FIG. 1;

FIG. 2B is a further enlarged exploded view of the coupling mechanism shown in FIG. 2A with the top-open container removed;

FIG. 3A is a top view of the reciprocating block of the coupling mechanism shown in FIG. 2A;

FIG. 3B is a front view of the reciprocating block shown in FIG. 3A;

FIG. 3C is a bottom view of the reciprocating block shown in FIG. 3A;

FIG. 3D is a side view of the reciprocating block shown in FIG. 3A; and

FIGS. 4A to 4D are top views of the relative positions of the components of the coupling mechanism shown in FIG. 2A during various stages of the operation of the electric toothbrush shown in FIG. 1.

### DETAILED DESCRIPTION OF THE PREFERRED EMBODIMENT

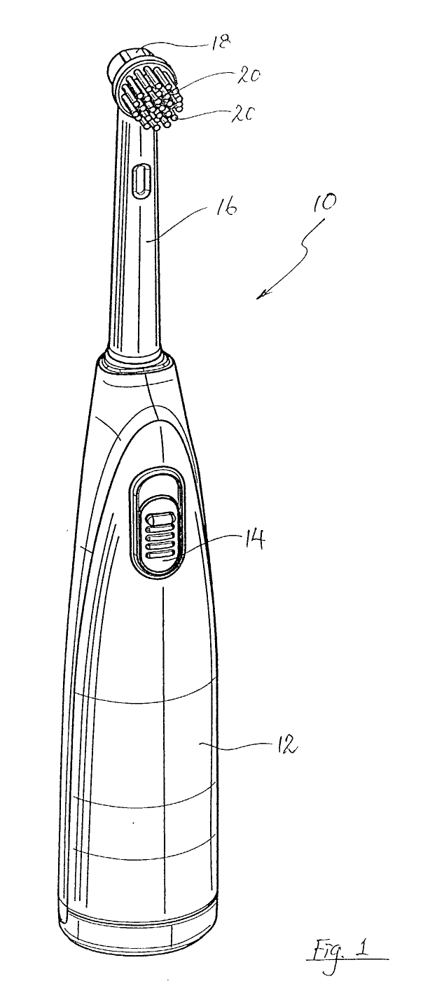

FIG. 1 shows a front perspective view of an electric toothbrush according to the present invention, generally designated as 10. The toothbrush 10 includes an elongate handle 12 including a slidable button 14 operable to activate or deactivate the toothbrush 10, as desired. Extending from an upper end of the handle 12 is a hollow elongate tube 16, which leads to a brush head 18, with a number of bristles 20 for brushing. The brush head 18 is fixedly engaged with a shaft (to be discussed below) which extends through the hollow elongate tube 16 into the interior of the toothbrush 10 for engagement with a coupling mechanism, to be discussed below. Housed in the handle 12 is a motor (to be discussed below) powerable by one or more dry batteries (not shown) also contained in the handle 12.

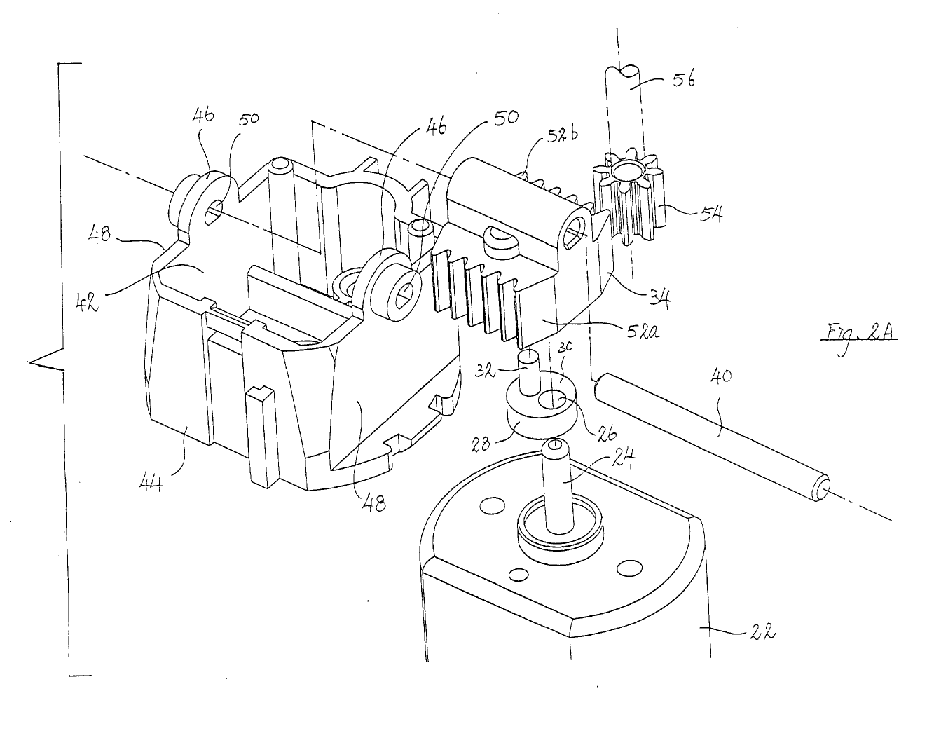

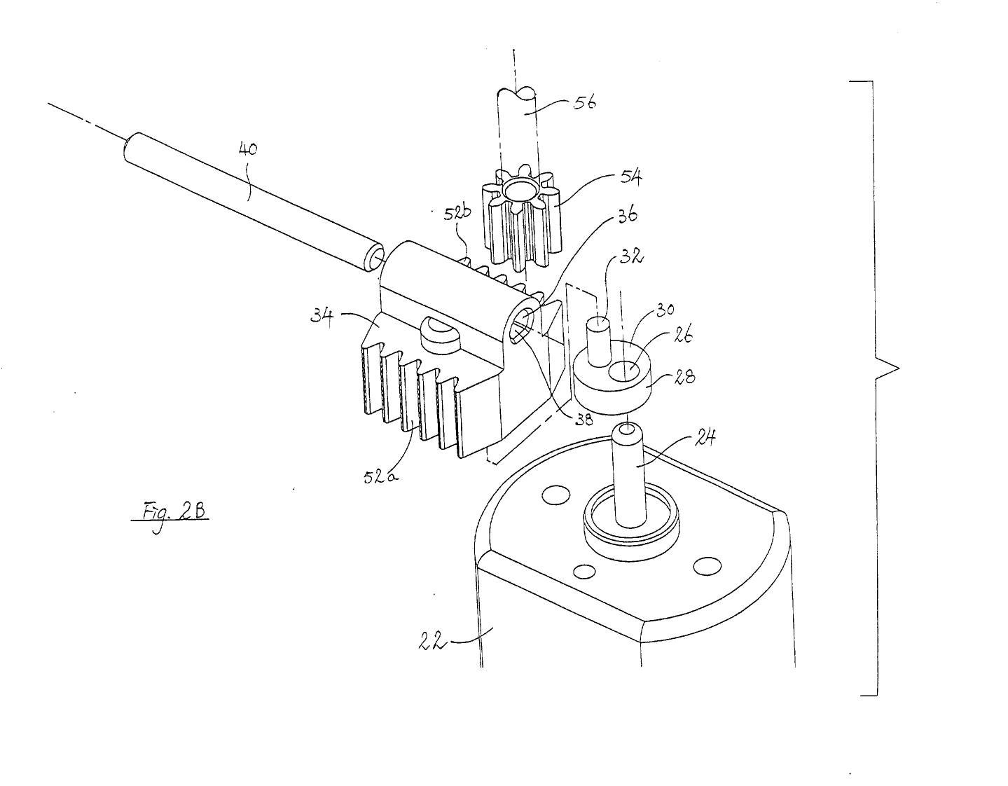

As shown in FIGS. 2A and 2B, an electric motor 22 housed in the handle 12 has an output spindle 24 which is fixedly fitted in an opening 26 of a revolving disc 28. Extending from an upper surface 30 of the disc 28 is a pin 32, which is received within an underside of a reciprocating block 34, in a manner to be discussed below. It can be seen that, when the motor 22 is activated, rotation of the spindle 24 will cause the disc 28 and the accompanying pin 32 to revolve about the longitudinal axis of the spindle 24.

The reciprocating block 34 has, on its upper part, a channel 36 running along its length. The channel 36 is generally circular in shape, but with a flat bottom surface 38. A correspondingly sized and shaped generally cylindrical rod 40 is received within the channel 36. As the rod 40 also has a partly flat outer surface which abuts the flat bottom surface 38 of the channel 36, the block 34 may only slide relative to the rod 40 along its length, with no relative swivelling or rotational movement. Although it is preferred to provide a flat bottom surface 38 in the channel 36 and a partly flat outer surface on the rod 40 which complement with each other, both flat surfaces may be dispensed with without significantly affecting the performance of the coupling mechanism.

As shown in FIG. 2A, the block 34 is hung and received within a cavity 42 of a top-open container 44 by the rod 40 for reciprocating movement. In particular, the container 44 has two ears 46 positioned on the upper edge of two opposite side walls 48. Each ear 46 has a hole 50 shaped and sized as the channel 36 of the reciprocating block 34. Thus, when the block 34 is placed in the cavity 42 of the container 44, the rod 40 may be inserted through a hole 50 of one ear 46, then through the channel 36, and subsequently through the hole 50 of another ear 46. By way of such an arrangement, the block 34 is hung within the cavity 42 for reciprocating movement relative to the rod 40, and along an axis parallel to the length of the rod 40.

On each lateral side of the block 34 is a row of gear teeth 52a, 56b. The gear teeth 52b are in mesh with a gear 54 fixed to a shaft 56. The brush head 18 is fixedly engaged with an upper end of the shaft 56 for simultaneous movement. By way of such an arrangement, reciprocating movement of the block 34 will set the shaft 56, and thus the brush head 18, into swivelling movement about its longitudinal axis. It can also be seen that the longitudinal axis of the shaft 56 is perpendicular to the rod 40.

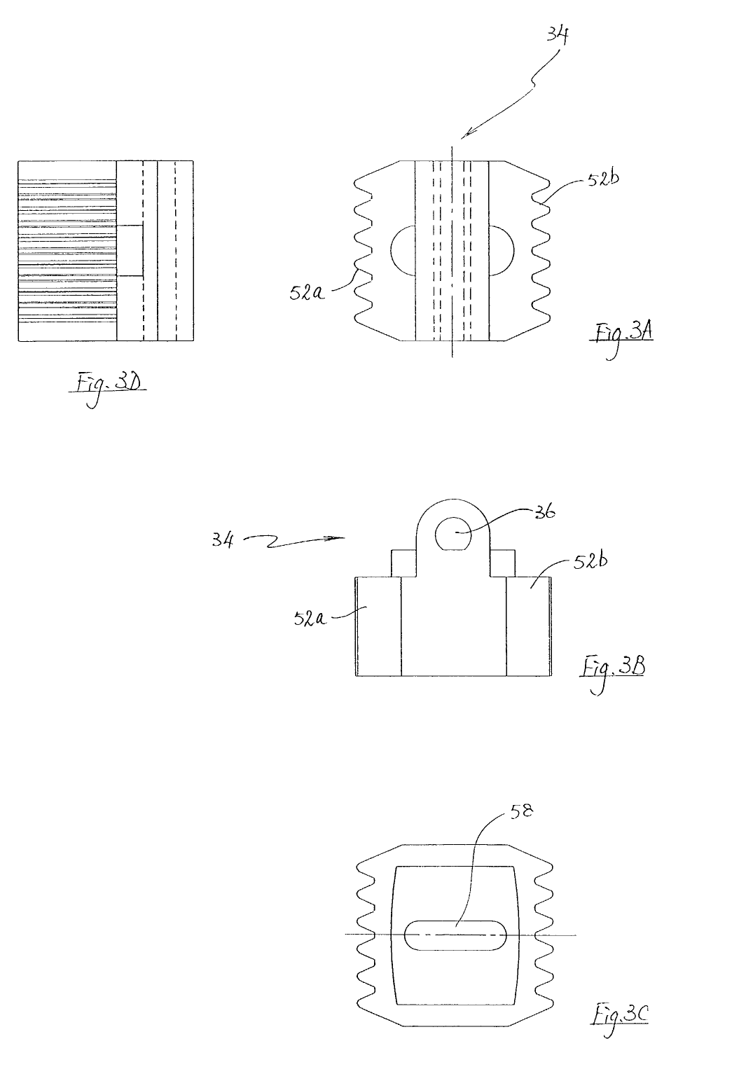

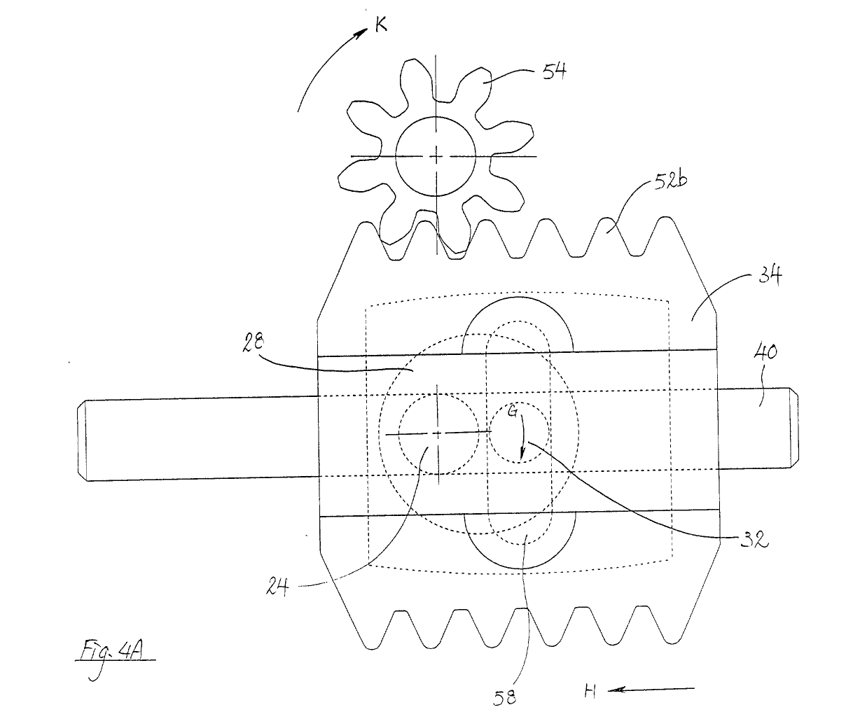

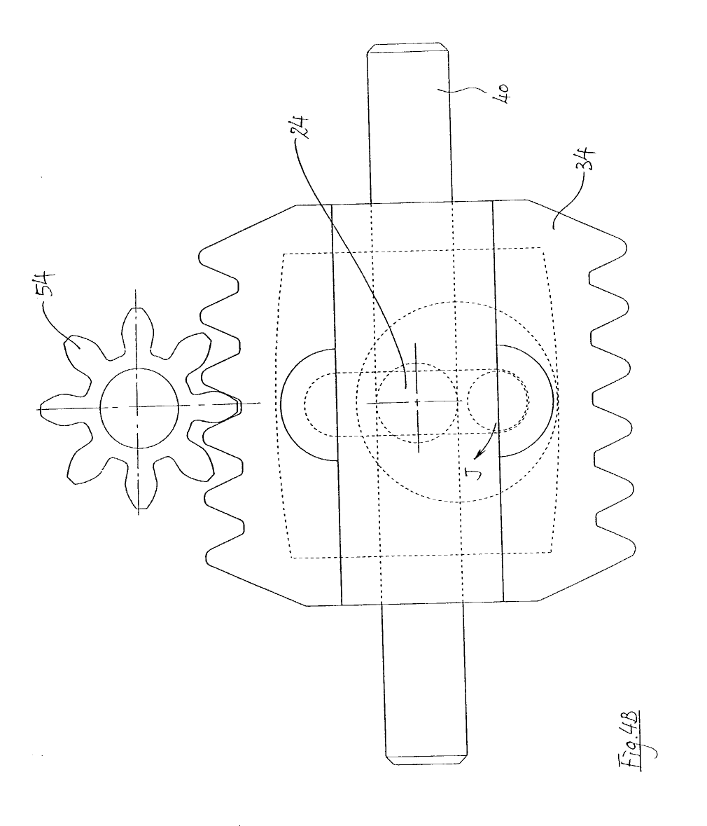

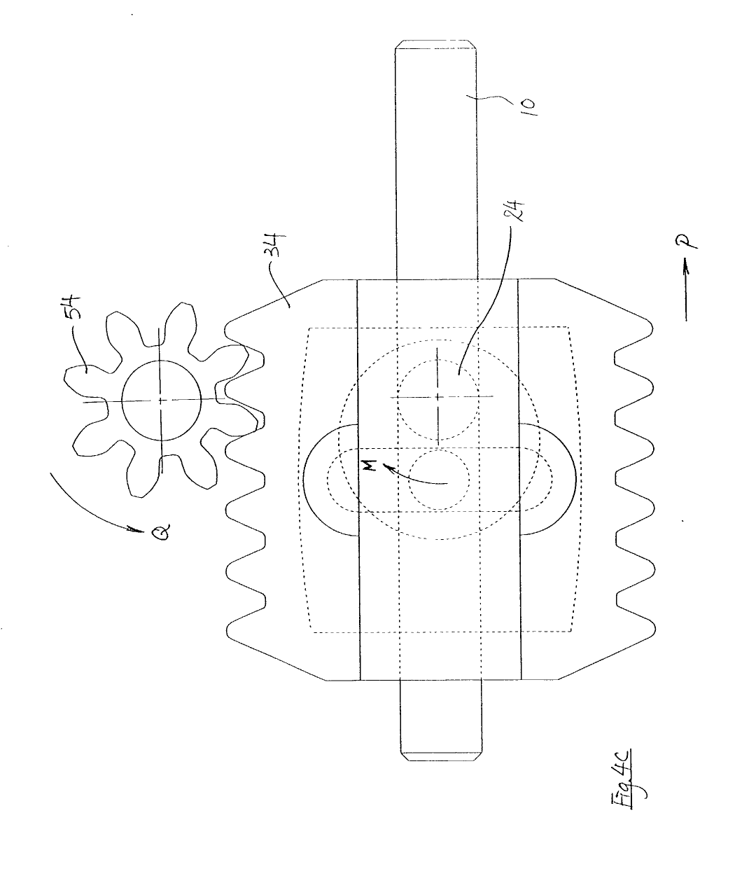

FIGS. 3A to 3D show various views of the reciprocating block 34. As can be seen more particularly in FIG. 3C, an elongate recess 58 is formed on an underside of the block 34 for receiving part of the pin 32 of the disc 28. The recess 58 is of a width the same or slightly larger than the diameter of the pin 32, to allow relative sliding movement of the pin 32 relative to the recess 58. It can also be seen that the length of the recess 58 is perpendicular to the length of the block 34.

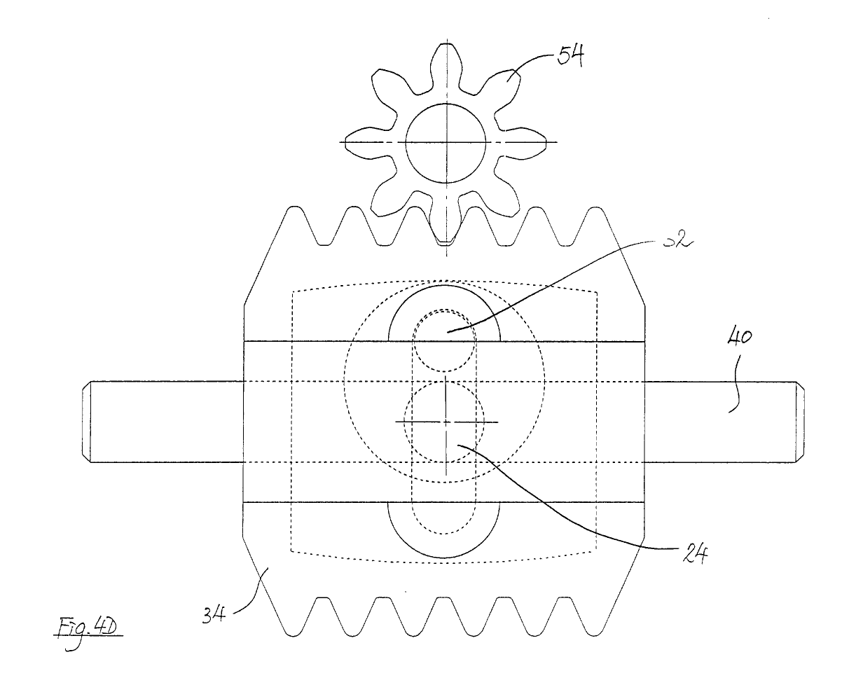

FIGS. 4A to 4D show respective plan views of the relative position between the gear 54, the block 34, the rod 40 and the revolving disc 28 of the toothbrush 10. It should be pointed out that the position of the longitudinal axis of the shaft 56, and thus of the gear 54, the longitudinal axis of the output spindle 24 of the motor 22, and the rod 40 are fixed relative to one another.

FIG. 4A shows the block 34 in the right-most position relative to the rod 40. When the motor 22 is activated, the spindle 24 rotates so that the pin 32 of the disc 28 revolves around the longitudinal axis of the spindle 24 in the direction indicated by the arrow G, until the pin 32 reaches the position shown in FIG. 4B. As the pin 32 is confined within the recess 58, and the movement of the block 34 is confined by the rod 40, the block 34 will slide relative to the rod 40 in the direction indicated by the arrow H, thus causing the gear 54, and thus the shaft 56 with which it is secured, to rotate in the direction indicated by the arrow K. When the spindle 24 further rotates, the pin 32 will revolve around the spindle 24 in the direction indicated by the arrow J shown in FIG. 4B, until the pin 32 reaches the position shown in FIG. 4C. It can be seen that the block 34 has moved further relative to the rod 40 in the direction of the arrow H, and the gear 54 has rotated further in the direction indicated by the arrow K. In particular, in the position shown in FIG. 4C, the block 34 is in the left-most position relative to the rod 40.

When the pin 32 further revolves around the spindle 24 in the direction shown by the arrow M in FIG. 4C, the block 34 will start to move in the direction shown by the arrow P in FIG. 4C, which is opposite to the direction indicated by the arrow H in FIG. 4A, and the gear 54 will start to rotate about its own longitudinal axis in the direction indicated by the arrow Q, which is opposite to the direction indicated by the arrow K in FIG. 4A. Further rotation of the pin 32 relative to the spindle 24 in the direction of the arrow M shown in FIG. 4C will bring the pin 32 to the position shown in FIG. 4D, thus causing the block 34 to slide relative to the rod 40 further in the direction indicated by the arrow P, which in turn causes the gear 54 to rotate further about its longitudinal axis in the direction indicated by the arrow Q. Further rotation of the spindle 24 in the same direction will bring the pin 32 back to the position shown in FIG. 4A, thus completing a cycle of rotational movement.

It can be seen that, by way of the coupling mechanism discussed above, upon activation of the motor 22, the spindle 24 will rotate, thus causing the block 34 to reciprocate along the rod 40, which in turn causes the gear 54, and the brush head 18 fixed thereto, to swivel back and forth about the longitudinal axis of the shaft 56.

It should be understood that the above only illustrates an example whereby the present invention may be carried out, and that various modifications and/or alterations may be made thereto without departing from the spirit of the invention.

It should also be understood that various features of the invention which are, for brevity, described here in the context of a single embodiment, may be provided separately or in any appropriate sub-combinations.

What is claimed is:

1. An electric toothbrush including an electric motor, a shaft member adapted to be engaged with a brush member, and a coupling mechanism operatively associated with said motor and said shaft member for transmitting the motional output of said motor to drive said shaft member to swivel substantially about its longitudinal axis, wherein said coupling mechanism includes a movable member adapted to reciprocate along a straight line which is substantially perpendicular to said longitudinal axis of said shaft member.

2. An electric toothbrush according to claim 1 wherein said shaft member is fixed with a gear member in mesh with a geared portion of said movable member.

3. An electric toothbrush according to claim 1 wherein said movable member includes a channel member for receiving a rod member, and wherein said movable member is adapted to reciprocate relative to said rod member.

4. An electric toothbrush according to claim 1 wherein said movable member is received and movable within a cavity of a containing member.

5. An electric toothbrush according to claim 4 wherein said movable member is engaged with said containing member via a rod member relative to which said movable member is movable.

6. An electric toothbrush according to claim 1 wherein an output spindle of said motor is engaged with a revolving member with a pin member adapted to revolve around the output spindle of said motor.

7. An electric toothbrush according to claim 6 wherein at least part of said pin member of said revolving member is received within an elongate recess on an underside of said movable member.

8. An electric toothbrush according to claim 7 wherein said recess has a length which is substantially perpendicular to the straight line along which said movable member is adapted to reciprocate.
